(19) United States
(12) Patent Application Publication
(10) Pub. No.: US 2007/0146977 A1
(43) Pub. Date: Jun. 28, 2007

(54) Sliding and folding type portable terminal

(75) Inventor: Won-Young Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/645,418

(22) Filed: Dec. 26, 2006

(30) Foreign Application Priority Data
Dec. 23, 2005 (KR) 2005-128773

(51) Int. Cl. G06F 1/16

(52) U.S. Cl. 361/680; 361/683

(57) ABSTRACT

Disclosed is a sliding and folding type portable terminal. The portable terminal includes a body housing including at least one first user interface unit; a sliding housing including at least one second user interface unit, the sliding housing moving while facing the body housing; and a folding housing including at least one third user interface unit, the folding housing being connected to the sliding housing by means of a hinge, facing the body housing, and being inclined against the body housing after completion of sliding.

### PRIORITY

This application claims priority to an application entitled “Sliding/Folding Combination Type Mobile Phone” filed with the Korean Intellectual Property Office on Dec. 23, 2005 and assigned Serial No. 2005-128773, the contents of which are incorporated herein by reference.

### BACKGROUND OF THE INVENTION

1. Field of the Invention

The present invention relates to a portable terminal including Digital Multimedia Broadcasting Phones (referred to as DMB phones), game phones, camera phones, MP3 phones, cellular phones, Personal Digital Assistants (referred to as PDAs), Personal Communication System (referred to as PCS) phones, and the like, and, in particular to sliding and folding type portable terminals.

2. Description of the Related Art

In general, “a portable terminal” refers to an electronic device, which a user can carry with him/her while wirelessly communicating with another user. In consideration of portability, design of such a portable terminal has tended not only towards compactness, slimness and lightness, but also towards providing multimedia capabilities to allow the user to pursue a wider variety of functions. In particular, future portable terminals will not only be used for many functions while still being compact and light, but also will be modified to be suitable for functioning in a multimedia environment and for providing internet access and functions.

Conventional portable terminals may be classified into various types according to their appearance, such as bar-type portable terminals, flip-type portable terminals, and folder-type portable terminals. The bar-type portable terminal has a single housing shaped like a bar. The flip-type portable terminal has a flip panel which is pivotally mounted to a bar-shaped housing by a hinge unit. The folder-type portable terminal has a folder coupled to a single bar-shaped housing by a hinge unit in such a manner that the folder can be rotated in order to be folded or unfolded from the housing.

Further, portable terminals may be classified as neck wearable-type terminals and wrist wearable-type terminals, according to the position at or the way in which a user wears the terminal. The neck wearable type terminal is one which a user wears around the neck using a lanyard or necklace, while the wrist wearable type terminal is one which a user wears around the wrist.

Additionally, portable terminals may be classified as rotation-type terminals and sliding-type terminals according to ways of opening and closing the terminals. In the rotation-type portable terminal, two housings are coupled to each other in a manner that one housing rotates to be opened or closed relative to the other while facing each other. In the sliding-type portable terminal, two housings are coupled to each other in a manner that one housing slides to be opened or closed relative to the other. The various classifications of portable terminals are easily understood by those skilled in the art.

Further, each of the conventional portable communication terminals has been converted to allow voice communication as well as high-speed data communication. That is, as consumer demands have increased, various services have been provided using wireless communication technology for transmitting and receiving data at a high speed.

Presently, many portable terminals have a camera lens mounted thereto to transmit image signals and the like, by means of an embedded or external camera lens module. Therefore, it is possible to perform image communication with a desired partner or to photograph a desired subject.

However, among the conventional portable terminals, the sliding type portable terminals cannot be securely fixed to a user's shoulder for hands-free usage while the user communicates with another partner, thereby causing the user to have an unstable posture. Since two housings are linearly arranged, it is difficult to support the portable terminal between the user's shoulder and ear. Where the portable terminal is dropped from the user's shoulder, the portable terminal is in danger of being subjected to great damage.

Further, in the sliding type portable terminal, since the body of the terminal is linearly aligned with the slider, the body and the slider come into contact with certain portions of the user's face, for example the ear and mouth, thereby causing the user to have an unstable posture. Further, there is a problem in that the conventional sliding type portable terminal must be supported by a separate cradle so as to be inclined in order for the user to watch various moving picture displayed on a display unit.

Further, while it maybe convenient for a user to communicate with another partner in a hand-free state in the conventional folding type portable terminal, it is inconvenient to watch moving pictures because a display unit mounted to the portable terminal has a small size.

### SUMMARY OF THE INVENTION

Accordingly, the present invention has been made to solve the above-mentioned problems occurring in the prior art, and an object of the present invention is to provide a sliding and folding type portable terminal which has all the advantages of a sliding type portable terminal and a folding type portable terminal.

Another object of the present invention is to provide a sliding and folding type portable terminal which is convenient to watch images displayed on a display unit.

Still another object of the present invention is to provide a sliding and folding type portable terminal which is convenient for a user to communicate with another user in a hands-free state having a structure such that a speaker unit and a microphone unit are adjacent to the user's ear and mouth after the portable terminal is open in a sliding manner.

Still another object of the present invention is to provide a sliding and folding portable terminal which includes a display unit capable of inclining itself so as to be convenient to watch various moving pictures in a DMB mode.

Still another object of the present invention is to provide a sliding and folding portable terminal which enables a display unit to be inclined without use of a separate cradle and has economical merit.

In order to accomplish these objects, there is provided a portable terminal which includes a body housing having at least one first user interface unit; a sliding housing including at least one second user interface unit, the sliding housing being movable while facing the body housing; and a folding housing including at least one third user interface unit, the folding housing being connected to the sliding housing by means of a hinge and being inclined with respect to the body housing after completion of sliding.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a sliding and folding type portable terminal according to the present invention;

FIG. 2 is a perspective view showing the sliding and folding type portable terminal according to the present invention, in which a sliding housing has slid;

FIG. 3 is a perspective view showing the sliding and folding type portable terminal according to the present invention, in which the sliding housing is slid and then a folding housing is rotated;

FIG. 4 is a perspective view showing the sliding and folding type portable terminal according to the present invention, in which the folding housing is rotated;

FIGS. 5A to 5C are side views of the sliding and folding type portable terminal according to the present invention, in which the opening processes of sliding and folding housings of the portable terminal are sequentially shown; and

FIGS. 6A to 6C are side views of the sliding and folding type portable terminal according to the present invention, in which the other opening processes of sliding and folding housings of the portable terminal are sequentially shown.

### DETAILED DESCRIPTION OF THE PREFERRED EMBODIMENT

Hereinafter, the preferred embodiment of the present invention will be described with reference to the accompanying drawings. In the following description of the present invention, a detailed description of known functions and configurations incorporated herein is omitted to avoid making the subject matter of the present invention unclear.

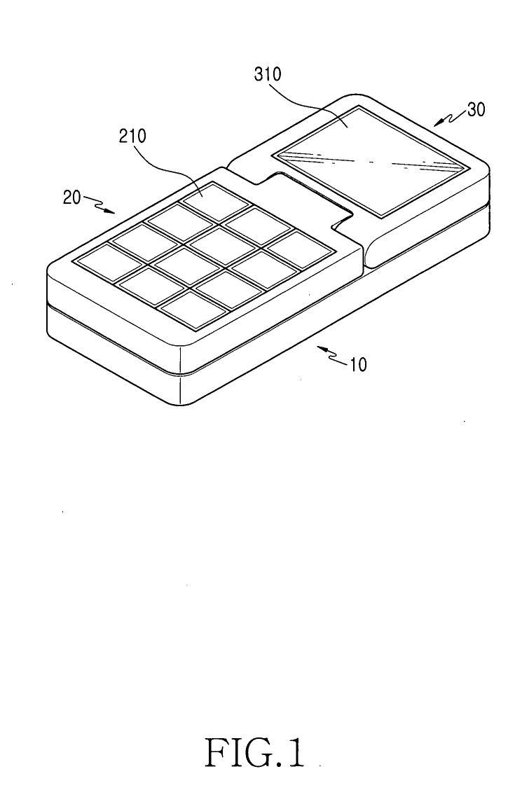

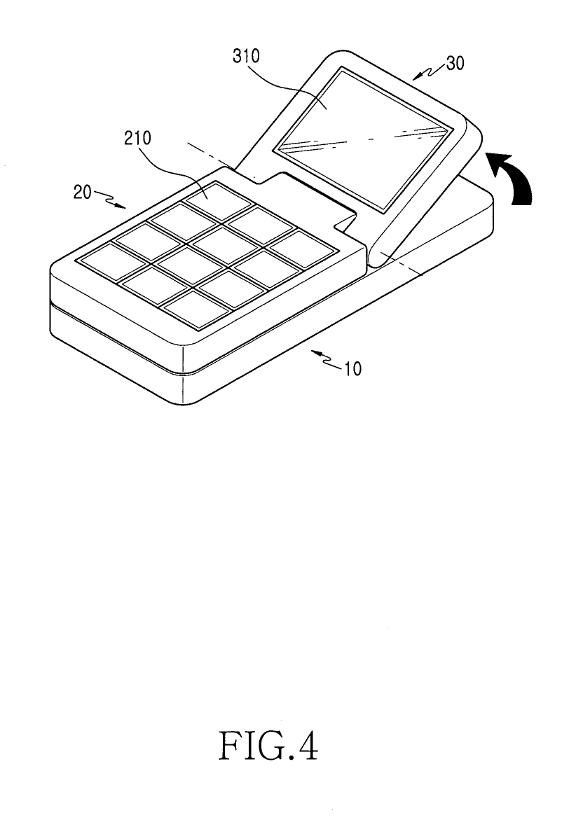

As shown in FIGS. 1 and 4, the portable terminal according to the present invention is a combination type of sliding and folding type portable terminals. Specifically, the present invention has the advantages of the sliding and folding type portable terminals, which includes three housings 10, 20 and 30 linked with one another. The portable terminal according to the present invention includes a body housing 10, a sliding housing 20, and a folding housing 30. The sliding housing 20 moves on the body housing 10 while being opposed to the body housing 10. Thus, the sliding housing 20 moves along an upper surface of the body housing so as to be open and closed. The folding housing 30 is rotatably connected to the sliding housing 20 by means of a hinge, and slides along with the sliding housing 20 on the body housing 10.

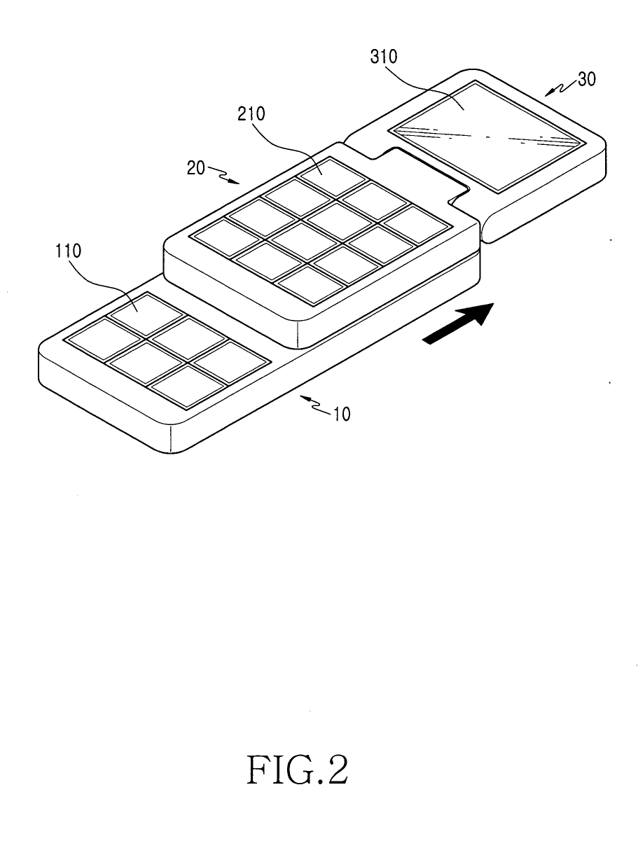

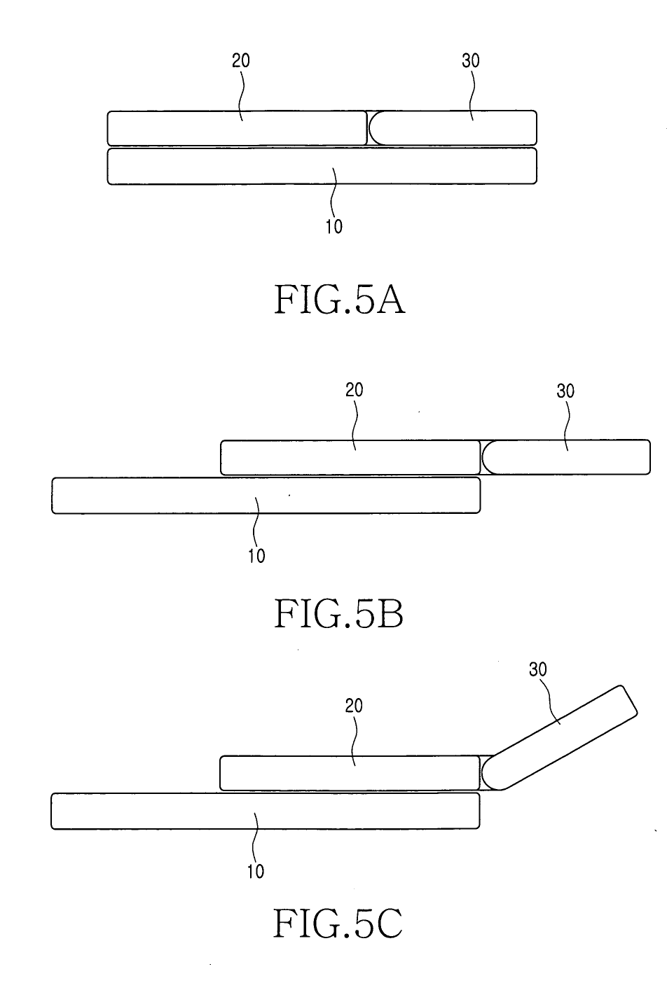

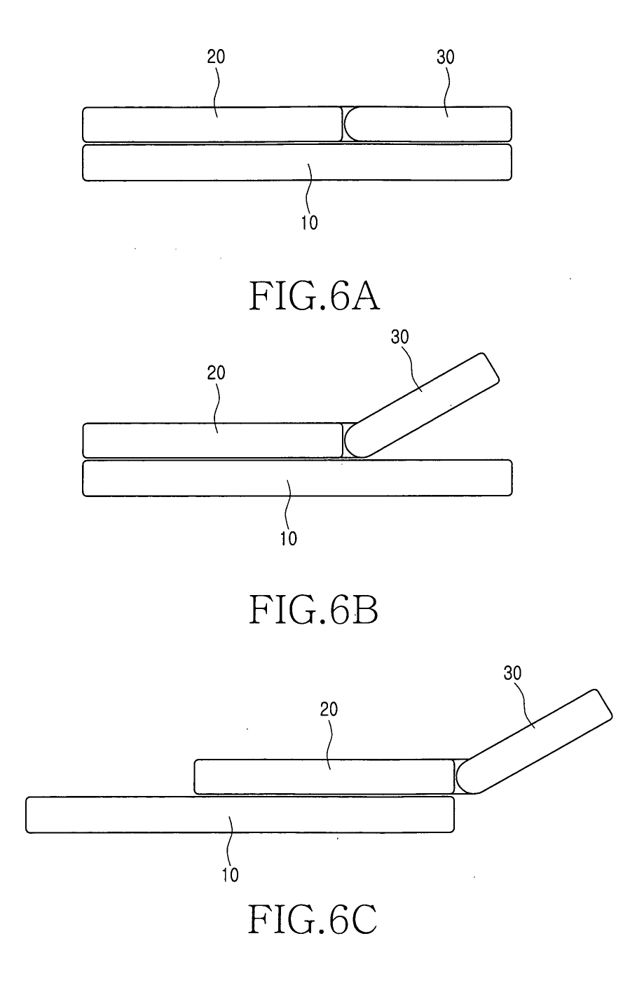

Preferably, the folding housing 30 may be constructed in such a manner of being rotated after the slide housing 20 slidably moves, or may be simultaneously rotated with the sliding movement of the sliding housing 20. The former is shown in FIGS. 5A to 5C, while the latter is shown in FIGS. 6A to 6C. As shown in FIG. 2, the rotation of the folding housing 30 will be described below.

The body housing 10 has at least one first user interface unit 110 disposed on the upper surface thereof. The first user interface unit 110 includes a plurality of first keys. Alternatively, the first user interface unit 110 may include a touch screen or a touch pad. FIG. 2 shows keys used as the first user interface unit 110. The sliding housing 20 has at least one second user interface unit 210 disposed on the upper surface thereof. The second user interface unit 210 includes a plurality of secondary keys. Alternatively, the second user interface unit 210 may be a touch screen or a touch pad. FIGS. 1, 2, 3 and 4 show keys used as the second user interface unit 210. The folding hosing 30 has at least one third user interface unit 310 disposed thereon. The third user interface unit 310 includes a liquid crystal display unit, a touch screen or a hologram screen.

Further, the body housing 10 has a microphone unit (not shown) mounted thereon. The folding housing 30 has a speaker unit (not shown) and a camera module, etc. mounted thereon. Alternatively, a sliding opening and closing device (not shown) may be mounted between the body housing 10 and the sliding housing 20. A hinge module (not shown) is mounted on a hinge axis of the sliding housing 20 and the folding housing 30 so as to connect the sliding housing 20 and the folding housing 30 to each other. In addition, a driving source making the sliding housing 20 move along the body housing, or a driving source making the folding housing 30 rotate, can operate automatically, semi-automatically, or be manually operated. The driving source, which is semi-automatically operated, may include a known resilient body, for example a plate spring, a torsion spring, a tension spring and the like. Further, the driving source, which is automatically operated, may include a known electric motor, a reduction gear, and the like.

The opening and closing of the portable terminal according to an embodiment of the present invention will be described with reference to FIGS. 5A to 5C. In FIG. 5A, when a user pushes the sliding housing 20 by a predetermined distance, the sliding housing 20 automatically move along the body housing 10 to a final position because of the force generated by the sliding opening and closing device (not shown) Subsequently, when the folding housing 30 is rotated by a predetermined angle, the folding housing automatically rotate to a final position because of the force provided by the hinge module (not shown). Consequently, the folding housing 30 performs a rotating operation after the sliding housing 20 slides. If a motor, spring, or spring hinge module is provided each movement may be done manually by the user or automatically.

Another process of opening and closing the portable terminal according to the embodiment of the present invention will be described with reference to FIGS. 6A to 6C. In FIG. 6A, when a user rotates the folding housing 30 by a predetermined angle, the folding housing 30 automatically rotate to a final position from the predetermined angle because of the force provided by the hinge module (not shown) to the folding housing 20. Next, when the user pushes the sliding housing 20 by a predetermined distance, the sliding housing 30 automatically move to the final position. This is a result of the sliding opening and closing device providing a force to the sliding housing 30. To that end, the folding housing 20 moves along with the sliding housing 30 after performing the rotation movement.

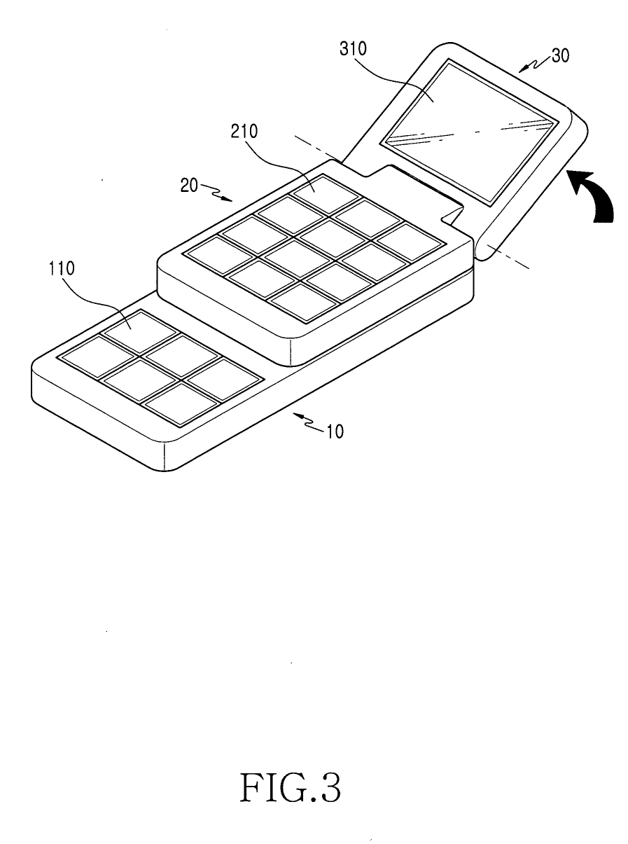

In the state of FIG. 3 or 4, since it is easy to make the speaker unit and the microphone unit come into close contact with a user's mouth and ear in a hands-free state, respectively, the user can easily communicate with another user. In particular, the user can easily communicate with another user by holding the terminal between his/her face and shoulder in the hands-free state. In addition, in the state of FIG. 3 or 4, the display unit is inclined, so that the user can conveniently watch displayed images. It is advantageous that a typical speaker unit is mounted over the display unit 310 and the typical microphone unit is mounted below the first keys 110. This takes into account a distance between the user's ear and mouth.

Alternatively, the sliding direction of the sliding housing 20 and the hinge axis of the folding housing 30 are perpendicular to each other. Further, the sliding direction of the sliding housing 20 is lengthwise with respect to the body housing 10. The hinge axis of the folding housing 30 is perpendicular to the length of the body housing 10.

As described above, the present invention has an ergonomic structure of meeting a face line of the user's face, thereby providing the user with a convenient communication attitude and allowing the user to stably communicate with another user. Moreover, the present invention has an advantage in that the user can watch displayed images, specifically in a DMB mode, because the sliding type display unit is allowed to be inclined. In addition, the present invention has an economical advantage in that there is no requirement for a separate cradle.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable terminal comprising:
a body housing including at least one first user interface unit;
a sliding housing including at least one second user interface unit, the sliding housing moving while facing the body housing; and
a folding housing including at least one third user interface unit, the folding housing being connected to the sliding housing by means of a hinge and being movable so as to be inclined with respect to the body housing.

2. The portable terminal as claimed in claim 1, wherein the sliding housing linearly moves in a direction of the body housing.

3. The portable terminal as claimed in claim 1, wherein the folding housing is rotatable after the completion of the movement of the sliding housing

4. The portable terminal as claimed in claim 1, wherein the folding housing is rotatable prior to sliding movement of the sliding housing.

5. The portable terminal as claimed in claim 1, wherein the rotating movement of the folding housing is carried out so that the folding housing is far from or close to the body housing in the state of facing the body housing.

6. The portable terminal as claimed in claim 1, wherein the first user interface unit includes a plurality of first keys, the second user interface unit includes a plurality of second keys, and the third user interface unit includes a display unit.

7. The portable terminal as claimed in claim 1, wherein the sliding housing semi-automatically moves, and the folding housing semi-automatically rotates.

8. The portable terminal as claimed in claim 1, wherein the sliding direction of the sliding housing and a rotation axis of the folding housing are perpendicular to each other.
